(19) United States
(12) Patent Application Publication
(10) Pub. No.: US 2007/0211670 A1
(43) Pub. Date: Sep. 13, 2007

(54) Avoiding Hsdpa Transmission During Idle Periods

(76) Inventor: Andreas Andersson, Landvetter (SE)

Correspondence Address: NIXON & VANDERHYE, PC, 901 NORTH GLEBE ROAD, 11TH FLOOR, ARLINGTON, VA, 22203, US

(21) Appl. No.: 11/587,646

(22) PCT Filed: Jun. 1, 2004
(86) PCT No.: PCT/SE04/00833

§ 371 Date: Oct. 26, 2006

(51) Int. Cl. H04B 7/216

(52) U.S. Cl. 370/335

(57) ABSTRACT

The invention refers to a method and a system for a MAC-hs scheduler in a mobile data transmission system for High-Speed Downlink Packet Access (HSDPA). The system comprises a Radio Network Controller (RNC) for control of at least one Base Transceiver Station (BTS) operating a cell comprising at least one user equipment (UE); where the Radio Network Control (RNC) schedules idle periods (IPDL) in the transmission from the BTS (BTS); where the MAC-hs scheduler is placed in the Base Transceiver Station (BTS) and determines for every High-Speed Transmission Time Interval (HS-TTI) if the UE will be granted High-Speed Physical Downlink Shared Channel (HS-PDSCH) data transmission.

### TECHNICAL FIELD

### Background Art

Abbreviations:

3GPP 3rd Generation Partnership Project
ARQ Automatic Repeat Request
BTS Base Transceiver Station
CPICH Common Pilot Channel
FDD Frequency Division Duplex
HARQ Hybrid Automatic Repeat Request
HS-DATA High Speed data
HSDPA High Speed Downlink Packet Access
HS-DPCCH High Speed Dedicated Physical Control Channel
HS-DSCH High Speed Downlink Shared Channel
HS-PDSCH High Speed Physical Downlink Shared Channel
HS-SCCH High Speed Signaling Control Channel
HS-TTI High Speed Transmission Time Interval, also known as a sub frame
MAC Medium Access Control
MAC-d MAC-dedicated
MAC-hs MAC-High Speed
QAM Quadrature Amplitude Modulation
RAN Radio Acess Network
RLC Radio Link Control
RNC Radio Network Controller
SFN System Frame Number
TDD Time Division Duplex
UE User Equipment
UMTS 3G standard promoted by ETSI and others
UTRA UMTS Terrestrial Radio Access
UTRAN UMTS Terrestrial Radio Access Network
WCDMA Wideband Code Division Multiple Acces

The 3rd Generation Partnership Project (3GPP) specification is a standard for the third generation mobile telephony system. The system supports different user data rates for different users. The transmission power used for a certain user is determined by interference level in a certain cell, user data rate, channel quality and requested quality of the data transmission in the cell.

The system (may for example be a WCDMA system) has a downlink transport channel called High Speed Downlink Shared Channel (HS-DSCH). The HS-DSCH provides enhanced support for interactive, background, and, to some extent streaming radio-access-bearer (RAB) services in the downlink direction. More specifically HS-DSCH allows for;

High capacity

Reduced delay

Significantly higher peak data rates

HS-DSCH transmission is based on Shared-Channel transmission, similar to the previously known Downlink Shared Channel (DSCH). However, HS-DSCH transmission supports several new features, not supported for DSCH.

HS-DSCH supports the use of higher order modulation. This allows for higher peak data rates and higher capacity.

HS-DSCH supports fast link adaptation and fast channel-dependent scheduling. This means that the instantaneous radio-channel conditions can be taken into account in the selection of transmission parameters as well as in the scheduling decision and allows for higher capacity.

HS-DSCH supports fast hybrid ARQ (HARQ) retransmission with soft combining. This reduces the number of retransmissions as well as the time between retransmissions and allows for higher capacity and a substantial reduction in delay. The use of hybrid ARQ (HARQ) retransmission with soft combining also adds robustness to the link adaptation.

The HS-DSCH is used in the MAC layer, which is present in the RNC and BTS and in the UE. The MAC layer is the layer above the physical layer (PHY) and the layer below the RLC layer. The RLC layer handles logical and the MAC layer handles transport channels.

To support the above features with minimum impact on the existing radio-interface protocol architecture the MAC layer has been extended by adding a MAC-hs sub layer. The MAC-hs sub layer is placed between the MAC-D layer and the PHY. Both sub layers are used for HS-DSCH transmission. MAC-hs is located in the BTS (also known as Node B) and in the UE in order to reduce the retransmission delay for hybrid ARQ and allow for as up-to-date channel-quality estimates as possible for the link adaptation and channel-dependent scheduling. For the same reasons, HS-DSCH uses a HS-TTI equal to 2 ms.

HS-DSCH is specified for both UTRA/FDD (WCDMA) and UTRA/TDD for the 3GPP specifications as of March 2003.

It is previously known that the BTS operates the cell and that a scheduling algorithm situated in the BTS determines for every HS-TTI which UE or UEss in the cell that will be granted transmission. The UE or UEs may be any mobile or fixed equipment operated, for example, by a person on foot or in a vehicle. The decision from the MAC-hs scheduler is performed for each HS-TTI.

The MAC-hs scheduler is placed in the BTS overlapping the MAC-hs layer and the PHY. The MAC-hs scheduler can be based on several parameters e.g. data waiting time, channel quality, UE capabilities and priority of important data. Node B can transmit data to several UE in parallel within a TTI.

To support time difference measurements for location services, idle periods are created in the downlink (hence the name IPDL) during which time transmission of all channels from a BTS is temporarily seized. During these idle periods the visibility of neighbour cells from the UE is improved.

The idle periods are arranged in a predetermined pseudo random fashion according to higher layer parameters. Idle periods differ from compressed mode in that they are shorter in duration, all channels are silent simultaneously, and no attempt is made to prevent data loss.

In general there are two modes for these idle periods:
Continuous mode, and;
Burst mode.

In continuous mode the idle periods are active all the time. In burst mode the idle periods are arranged in bursts where each burst contains enough idle periods to allow a UE to make sufficient measurements for its location to be calculated. The bursts are separated by a period where no idle periods occur. Today the idle period is about 0.5 slot to 1 slot long.

One problem with existing solutions is that the idle periods affect the effectiveness of the system since the retransmission function in the MAC-hs in the BTS has to perform and request a number of retransmissions due to the fact that HS-PDSCH and/or HS-DSCH data is transmitted during the idle period.

There is thus a need for an improved and more effective system.

### DISCLOSURE OF INVENTION

The invention intends to solve the problem with finding a better solution for transmission of data in a HS-PDSCH. The problem is solved by an arrangement and a method according to the appended claims.

The invention refers to a method for a MAC-hs scheduler in a mobile data transmission system for High-Speed Downlink Packet Access (HSDPA), where the system comprises a Radio Network Control (RNC) for control of at least one Base Transceiver Station (BTS) operating at least one cell comprising at least one user equipment (UE). The Radio Network Control (RNC) schedules idle periods in the transmission from the BTS. The MAC-hs scheduler is placed in the Base Transceiver Station (BTS) and determines for every High-Speed Transmission Time Interval (HS-TTI) if the UE will be granted High-Speed Physical Downlink Shared Channel (HS-PDSCH) data transmission.

The method is characterised in that the MAC-hs scheduler identifies the idle period and prohibits HS-PDSCH data transmission if the HS-TTI coincides with at least one idle period.

One advantage of the invention is that useless transmission is avoided. In the previously known solutions the MAC-hs scheduler does not take any idle periods from Idle Periods Down Link (IPDL) into consideration when deciding which UE will be granted transmission. Therefore, all HS-PDSCH data transmitted during a HS-TTI that coincide with an idle period will have to be retransmitted. This is a problem because of, for example, interference. The present invention thus gives a solution to the problem with interference.

Furthermore, the present invention delays the transmission for one HS-TTI whereas any previously known system for retransmission delays the transmission at least six HS-TTI if the HARQ retransmission are capable of handling retransmissions before a possible timeout. The present invention thus gives a solution to the problem with increased delay due to too much retransmission and therefore gives a more efficient system.

The RNC schedules idle periods being at least one half or one slot long, where one slot is one third of a HS-TTI (HS-TTI). Since the idle period can be as long as one time slot, it is a waste of recourses to transmit any HS-DSCH data during the idle period, which the present invention advantageously hinders.

In one embodiment of the invention, the HS-TTI (HS-TTI) allows transmission during 2 ms.

The present invention mainly refers to the present 3GPP and the up to date data regarding that system. In a future version of the system, one time slot may have a different length than the above stated, which is true also for the HS-TTI.

As has been described in prior art the MAC-hs scheduler spans over the MAC-hs and a physical layer (PHY).

The invention also refers to a mobile data transmission system for High-Speed Downlink Packet Access (HSDPA), where the system comprises a Radio Network Control (RNC) for control of at least one Base Transceiver Station (BTS) operating a cell comprising at least one user equipment (UE). The RNC comprises means for scheduling idle periods in the transmission from the BTS. The MAC-hs scheduler is placed in the BTS and arranged to determine for every HS-TTI if the UE will be granted HS-PDSCH data transmission.

The system is characterised in that the MAC-hs scheduler is arranged to identify the idle period and prohibit HS-PDSCH data transmission if the HS-TTI coincides with at least one idle period.

The advantages of the system have been described in connection to the method above.

The invention is below defined in view of the present 3GPP-system, but in a future system a number of data could be changed.

To support time difference measurements for location services, idle periods are created in the downlink (hence the name IPDL) during which time transmission of all channels from the BTS is temporarily seized. During these idle periods the visibility of neighbouring cells from the UE is improved.

The idle periods are arranged in a predetermined pseudo random fashion according to higher layer parameters. Idle periods differ from compressed mode in that they are shorter in duration, all channels are silent simultaneously, and no attempt is made to prevent data loss.

In general there are two modes for these idle periods:
Continuous mode, and;
Burst mode.

In continuous mode the idle periods are active all the time. In burst mode the idle periods are arranged in bursts where each burst contains enough idle periods to allow a UE to make sufficient measurements for its location to be calculated. The bursts are separated by a period where no idle periods occur.

In one example the following parameters are signalled to the UE via higher layers:

IP_Status: This is a logic value that indicates if the idle periods are arranged in continuous or burst mode.

IP_Spacing: The number of 10 ms radio frames between the start of a radio frame that contains an idle period and the next radio frame that contains an idle period. Note that there is at most one idle period in a radio frame.

IP_Length: The length of the idle periods, expressed in symbols of the CPICH.

IP_Offset: A cell specific offset that can be used to synchronise idle periods from different sectors within the BTS.

Seed: Seed for the pseudo random number generator.

Additionally in the case of burst mode operation the following parameters are also communicated to the UE.

Burst_Start: Specifies the start of the first burst of idle periods. 256×Burst Start is the SFN (System Frame Number) where the first burst of idle periods starts.

Burst_Length: The number of idle periods in a burst of idle periods.

Burst_Frequency: Specifies the time between the start of a burst and the start of the next burst. 256×Burst_Freq is the number of radio frames of the primary CPICH between the start of a burst and the start of the next burst.

One example of how an idle period position is calculated is as follows:

In burst mode, burst #0 starts in the radio frame with SFN=256×Burst_Start. Burst #k starts in the radio frame with SFN=256×Burst_Start+k×256×Burst_Freq(k=0,1,2, . . . ). The sequence of bursts according to this formula continues up to and including the radio frame with SFN=4095. At the start of the radio frame with SFN=0, the burst sequence is terminated (no idle periods are generated) and at SFN=256×Burst_Start the burst sequence is restarted with burst #0 followed by burst #1 etc., as described above.

Continuous mode is equivalent to burst mode, with only one burst spanning the whole SFN cycle of 4096 radio frames, this burst starting in the radio frame with SFN=0.

Assume that IP_Position (x) is the position of idle period number x within a burst, where x=1, 2, . . . , and IP_Position (x) is measured in number of CPICH symbols from the start of the first radio frame of the burst.

The positions of the idle periods within each burst are then given by the following equation:
IP_Position (x)=(x×IP_Spacing×150)+(rand(x modulo 64) modulo (150−IP_Length))+IP_Offset;
where rand(m) is a pseudo random generator defined as follows:
rand(0)=Seed;
rand(m)=(106×rand(m−1)+1283) modulo 6075, m=1, 2, 3,

Note that x is reset to x=1 for the first idle period in every burst.

The invention is preferably used in a data transmission system such as the previously known UMTS using HS-PDSCH, but may also be used in a different system where data (preferably data packets) is communicated between user equipments and base stations.

HS-DSCH transmission is based on five main technologies: shared-channel transmission, higher-order modulation, link adaptation, radio-channel-dependent scheduling, and hybrid ARQ with soft combining.

Shared-channel transmission implies that a certain amount of radio resources of a cell (code space and power in case of CDMA) is seen as a common resource that is dynamically shared between users, primarily in the time domain. Transmission by means of the WCDMA Downlink Shared Channel (DSCH) is one example of shared-channel transmission. The main benefit with DSCH transmission is more efficient utilization of available code resources compared to the use of a dedicated channel, i.e. reduced risk for code-limited downlink. However, with the introduction of HS-DSCH, several other benefits of shared-channel transmission can be exploited.

However, in order to further explain the invention references are made to an HSDPA system. HSDPA is a service where a Node B (the BTS) determines the amount of data to be transmitted, when to transmit as well as the used transmission power.

There is a new HSDPA transmission every HS-TTI. This corresponds to a High-Speed Time Transport Time Interval (HS-TTI) of 2 ms. The invention is not restricted to a TTI of 2 ms, but may use another time interval.

Below the HSDPA will be explained further as an example of how a data transmission system according to the invention may be structured.

High Speed Downlink Packet Access (HSDPA) is a packet-based data service in W-CDMA downlink with data transmission of up to 14 Mbps over a 5 MHz bandwidth in WCDMA downlink. HSDPA implementations include Adaptive Modulation and Coding (AMC), Hybrid Automatic Request (HARQ), fast cell search, and advanced receiver design.

In the 3rd generation partnership project (3GPP) standards have been developed to include HSDPA. 3G Systems are intended to provide global mobility with a wide range of services including telephony, paging, messaging, Internet and broadband data. All 3G standards where HSDPA is a part are under constant development. An example of such developments is to use HSDPA.

UMTS offers teleservices (like speech or SMS) and bearer services, which provide the capability for information transfer between access points. It is possible to negotiate and renegotiate the characteristics of a bearer service at session or connection establishment and during ongoing session or connection.

A UMTS network consist of three interacting domains; Core Network (CN), UMTS Terrestrial Radio Access Network (UTRAN) and User Equipment (UE). The main function of the core network is to provide switching, routing and transit for user traffic. Core network also contains the databases and network management functions.

The UTRAN provides the air interface access method for User Equipment. The Base Station is referred to as Node-B and the control equipment for Node-Bs is called Radio Network Controller (RNC).

The Core Network is divided in circuit switched and packet switched domains.

The architecture of the Core Network may change when new services and features are introduced.

Wide band CDMA technology was selected for the UTRAN air interface. UMTS WCDMA is a Direct Sequence CDMA system where user data is multiplied with quasi-random bits derived from WCDMA Spreading codes. In UMTS, in addition to channelisation, Codes are used for synchronisation and scrambling. WCDMA has two basic modes of operation: Frequency Division Duplex (FDD) and Time Division Duplex (TDD).

The functions of Node-B are:
Air interface Transmission/Reception
Modulation/Demodulation
CDMA Physical Channel coding
Micro Diversity
Error Handing
Closed loop power control
scheduling of HSDPA data

The functions of RNC are:
Radio Resource Control
Admission Control
Channel Allocation
Power Control Settings
Handover Control
Macro Diversity
Ciphering
Segmentation/Reassembly
Broadcast Signalling
Open Loop Power Control

The UMTS standard does not restrict the functionality of the UE in any way. Terminals work as an air interface counter part for Node-B.

### BRIEF DESCRIPTION OF DRAWINGS

The invention will below be described in connection to a number of drawings where;

FIG. 1 schematically shows a system according to the invention, and where;

FIG. 2 schematically teaches a block diagram over the method according to the invention.

### MODE FOR CARRYING OUT THE INVENTION

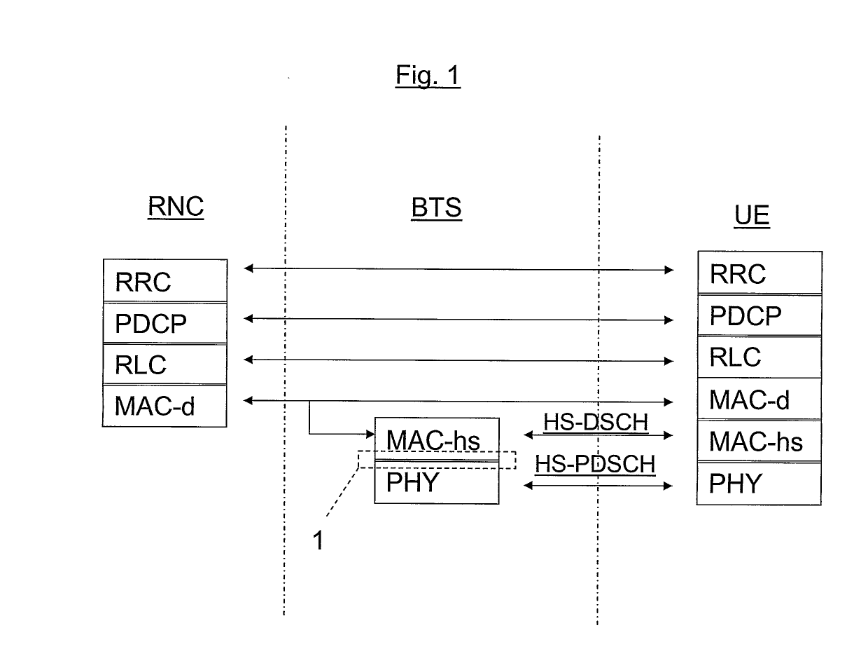

FIG. 1 schematically shows a mobile data transmission system according to the invention. The system comprises a Radio Network Control (RNC) for control of at least one Base Transceiver Station (BTS) operating a cell comprising at least one User Equipment (UE). The RNC schedules idle periods in the transmission from the BTS. The system comprises a MAC-hs scheduler 1 placed in the BTS and determines for every High-Speed Transmission Time Interval (HS-TTI) if the UE will be granted High-Speed Physical Downlink Shared Channel (HS-PDSCH) data transmission. The MAC-hs scheduler identifies the idle period and prohibits HS-PDSCH data transmission if the HS-TTI coincides with at least one idle period.

In FIG. 1 the MAC-hs scheduler spans over the MAC-hs (MAC-hs) and a physical layer (PHY).

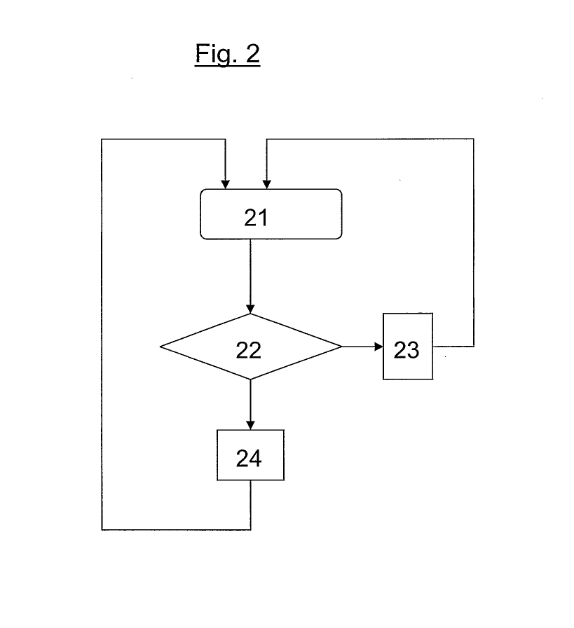

FIG. 2 shows a block diagram over the method according to the invention. The MAC-hs scheduler uses an algorithm that examines whether the idle period coincides with a HS-TTI. In FIG. 2, block 21 comprises the step of information gathering from the RNC. Block 22 comprises the step of analysing the information and comparing the idle period and the HS-TTI.

Block 23 represents the situation where the idle period coincides with the HS-TTI. The block 23 then comprises the step of not allowing the HS-PDSCH data transmission from the UE.

Block 24 represents the situation where the idle period does not coincide with the HS-TTI. The block 24 then comprises the step of allowing the HS-PDSCH data transmission from the UE.

1. Method for a MAC-hs scheduler in a mobile data transmission system for High-Speed Downlink Packet Access (HSDPA), where the system comprises a Radio Network Controller (RNC) for control of at least one Base Transceiver Station (BTS) operating a cell comprising at least one user equipment (UE);
where the Radio Network Control (RNC) schedules idle periods (IPDL) in the transmission from the BTS (BTS);
where the MAC-hs scheduler is placed in the Base Transceiver Station (BTS) and determines for every High-Speed Transmission Time Interval (HS-TTI) if the UE will be granted High-Speed Physical Downlink Shared Channel (HS-PDSCH) data transmission;
and, characterized in that the MAC-hs scheduler identifies the idle period and prohibits HS-PDSCH (HS-PDSCH) data transmission if the HS-TTI (HS-TTI) coincides with at least one idle period.

2. Method according to claim 1, characterized in that the RNC schedules idle periods being at least one half or one slot long, where one slot is one third of a HS-TTI (HS-TTI).

3. Method according to claim 1, characterized in that the HS-TTI (HS-TTI) allows transmission during 2 ms.

4. Method according to claim 1, characterized in that the MAC-hs scheduler spans over the MAC-hs (MAC-hs) and a physical layer (PHY).

5. A mobile data transmission system for High-Speed Downlink Packet Access (HSDPA), where the system comprises a Radio Network Control (RNC) for control of at least one Base Transceiver Station (BTS) operating a cell comprising at least one user equipment (UE);
where the Radio Network Control (RNC) comprises means for scheduling idle periods (IPDL) in the transmission from the BTS (BTS);
where the MAC-hs scheduler is placed in the Base Transceiver Station (BTS) and arranged to determine for every High-Speed Transmission Time Interval (HS-TTI) if the UE will be granted High-Speed Physical Downlink Shared Channel (HS-PDSCH) data transmission;
and, characterized in that the MAC-hs scheduler is arranged to identify the idle period and prohibit HS-PDSCH (HS-PDSCH) data transmission if the HS-TTI (HS-TTI) coincides with at least one idle period.

6. A mobile data transmission system according to claim 5, characterized in that each idle period is at least one half or one slot long, where one slot is one third of a HS-TTI (HS-TTI).

7. A mobile data transmission system according to claim 5, characterized in that the HS-TTI (HS-TTI)=2 ms.

8. A mobile data transmission system according to claim 5, characterized in that the MAC-hs scheduler spans over the MAC-hs (MAC-hs) and a physical layer (PHY).
